(19) United States
(12) Patent Application Publication
(10) Pub. No.: US 2012/0194662 A1
(43) Pub. Date: Aug. 2, 2012

(54) METHOD AND SYSTEM FOR MULTISPECTRAL PALMPRINT VERIFICATION

(75) Inventors: Dapeng David Zhang, Hong Kong (HK); Zhenhua Guo, Shenzhen (CN); Guangming Lu, Shenzhen (CN); Nan Luo, Shenzhen (CN)

(73) Assignee: THE HONG KONG POLYTECHNIC UNIVERSITY, Hung Hom (HK)

(21) Appl. No.: 13/015,581

(22) Filed: Jan. 28, 2011

(51) Int. Cl. H04N 7/18; G06K 9/00

(52) U.S. Cl. 348/77; 382/115; 348/E07.085

(57) ABSTRACT

A method for palmprint verification of an individual that includes illuminating a palm of an individual with a plurality of spectral bands, collecting a plurality of palmprint images that are illuminated under the different spectral bands, locating a sub-image from each of the plurality of palmprint images, extracting palmprint feature maps from the sub-images, determining a palmprint matching score for each of the spectral bands based on the palmprint feature maps, computing a fused score by combining at least two of the palmprint matching scores under different spectral bands, without double-counting overlapping regions, and comparing the fused score with a threshold score from a database.

### BACKGROUND OF THE INVENTION

1. Field of the Invention

The present invention relates to biometric recognition, and in particular to a method for analyzing a palmprint for recognition of an individual using multispectral analysis.

2. Description of the Related Art

Biometrics refers to the study of methods for recognizing humans based on one or more physical or behavioral traits. As an important biometrics characteristic, palmprint has been attracting much attention because of its merits, such as high speed, user friendliness, low cost, and high accuracy. However, there is room for improvement of online palmprint systems in the aspects of accuracy and security. Although 3-D imaging could be used to address these issues, 3-D imaging machines are typically expensive and bulky, and thus, it is difficult to be applied for real applications. One solution to these problems can be multispectral imaging, which captures an image in a variety of spectral bands. Each spectral band highlights specific features of the palm, making it possible to collect more information to improve the accuracy and anti-spoofing capability of palmprint biometric systems.

Multispectral analysis has been used in various palm-related authentications. For example, Rowe et al., “A Multispectral whole-hand biometric authentication system”, discloses a system for collecting palmprint information with clear fingerprint features, and the imaging resolution was set to 500 dpi. However, the low speed of feature extraction and feature matching makes it unsuitable for real-time applications.

In another example, Likforman-Sulem et al. used multispectral images in a multimodal authentication system; however, their system uses an optical desktop scanner and a thermal camera, which make the system very costly. The imaging resolution is also too high (600 dpi, the FBI fingerprint standard) to meet the real-time requirement in practical biometric systems.

In yet another example, Wang et al. disclosed a palmprint and palm vein fusion system that could simultaneously acquire two kinds of images. The system uses one color camera and one near infrared (NIR) camera, and requires a registration procedure of about 9 s. In yet another example, Hao et al., developed a contact-free multispectral palm sensor. However, the image quality is limited, and hence, the recognition accuracy is not very high. Overall, multispectral palmprint scanning is a relatively new topic, and the aforementioned works stand for the state-of-the-art work.

The information presented by multiple biometric measures can be consolidated at four levels: 1) image level; 2) feature level; 3) matching score level; and 4) decision level. Wang et al. fused palmprint and palm vein images by using a novel edge-preserving and contrast-enhancing wavelet fusion method for use of the personal recognition system. Some good results in accuracy were reported, but the image registration procedure in it takes 9 s, which hinders it from real-time implementation. In “Multispectral palm image fusion for accurate contact-free palmprint recognition”, Hao et al. proposed a new feature-level registration method for image fusion. Although image- and feature-level fusion can integrate the information provided by each spectral band, the required registration procedure is complicated and time consuming. As to matching score fusion and decision level fusion, it has been discussed in “Handbook of Multibiometrics” (Ross, et al.) that the former works better than the latter because match scores contain more information about the input pattern, and it is easy to access and combine the scores generated by different matchers. For these reasons, information fusion at score level is a commonly used approach in multimodal biometric systems and multispectral palmprint systems.

In view of the above systems, there still exists a need for a low-cost multispectral palmprint verification system that can operate in real time and acquire high-quality images.

### SUMMARY OF THE INVENTION

According to an aspect of the present invention, it provides a method for palmprint verification of an individual, the method includes illuminating a palm of an individual with a plurality of spectral bands, collecting a plurality of palmprint images that are illuminated under the different spectral bands, locating a sub-image from each of the plurality of palmprint images, extracting palmprint feature maps from the sub-images, determining a palmprint matching score for each of the spectral bands based on the palmprint feature maps, computing a fused score by combining at least two of the palmprint matching scores under different spectral bands, without double-counting overlapping regions, and comparing the fused score with a threshold score from a database.

According to another aspect of the present invention, it provides a system for palmprint verification of an individual, includes an illuminating unit configured to illuminate a palm of an individual with a plurality of spectral bands, an image acquisition unit configured to collect a plurality of palmprint images that are illuminated under the different spectral bands, and a computer configured to locate a sub-image from each of the plurality of palmprint images; extract palmprint feature maps from the sub-images; determine a palmprint matching score for each of the spectral bands based on the palmprint feature maps; compute a fused score by combining at least two of the palmprint matching scores under different spectral bands, without double-counting overlapping regions; and compare the fused score with a threshold score from a database.

Further features and aspects of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 illustrates a cross-sectional anatomy of human skin.

FIG. 2 illustrates an exemplary configuration of the present multispectral palmprint verification system.

FIGS. 3A-3D illustrate examples of palmprint images captured under different light spectra.

FIGS. 4A-4D illustrate the cropped images of FIGS. 3A-3D.

FIG. 5 illustrates an exemplary process flow of the present multispectral palmprint verification.

FIG. 6 illustrates feature maps extracted from FIGS. 4A to 4D.

FIG. 7 illustrates an example of sum score fusion.

FIG. 8 illustrates an example of overlapping features between different spectra.

### DESCRIPTION OF THE EMBODIMENTS

The accompanying drawings, which are incorporated in and constitute a part of the specification, illustrate embodiments of the invention and, together with the description, serve to explain the principles of the invention.

The present palmprint biometric system collects palmprint images in visible and NIR spectra. In comparison with traditional palmprint recognition approaches, the present system improves recognition accuracy by fusing the information provided by multispectral palmprint images at the score level. In addition, by utilizing the correlation between spectra, the present system is robust to anti-spoof attack.

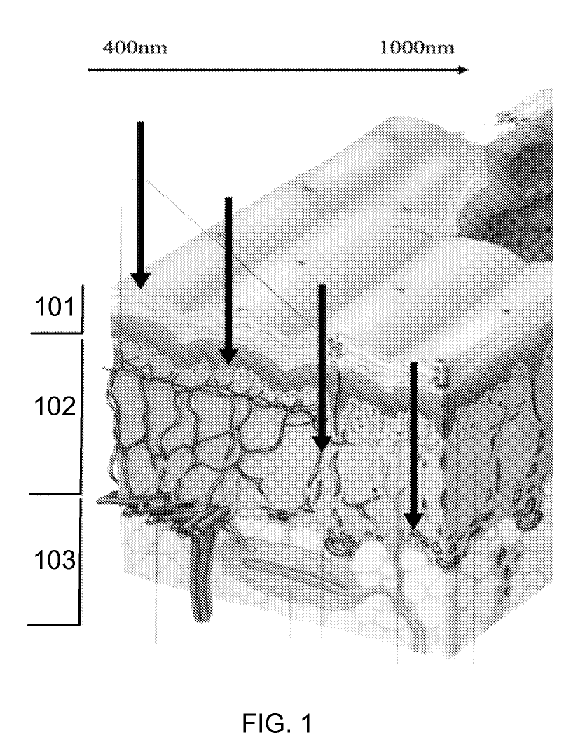

The two basic considerations in the design of a multispectral palmprint system are the followings: 1) the color-absorptive and color-reflective characteristics of human skin and 2) the light spectra to be used when acquiring images. Human skin is made up of three layers, namely epidermis (101), dermis (102), and subcutis (103), as shown in FIG. 1. The epidermis also contains melanin, whereas the subcutis contains veins. Different light wavelengths will penetrate to different skin layers and illuminate under different spectra. NIR light penetrates human tissue further than visible light, and blood absorbs more NIR energy than the surrounding tissue (e.g., fat or melanin).

The present system acquires spectral information from all three dermal layers by using both visible and NIR bands. In the visible spectrum, a three-monocolor LED array is used with Red peaking at 660 nm, Green peaking at 525 nm, and Blue peaking at 470 nm. In the NIR spectrum, an NIR LED array peaking at 880 nm is used. Multispectral light 202 is capable of sequentially illuminating at the above spectrums. As discussed in “Infrared imaging of subcutaneous veins” by Zharov et al., light in the 700-nm to 1000-nm range can penetrate human skin, whereas 880-930 nm provides a good contrast of subcutaneous veins.

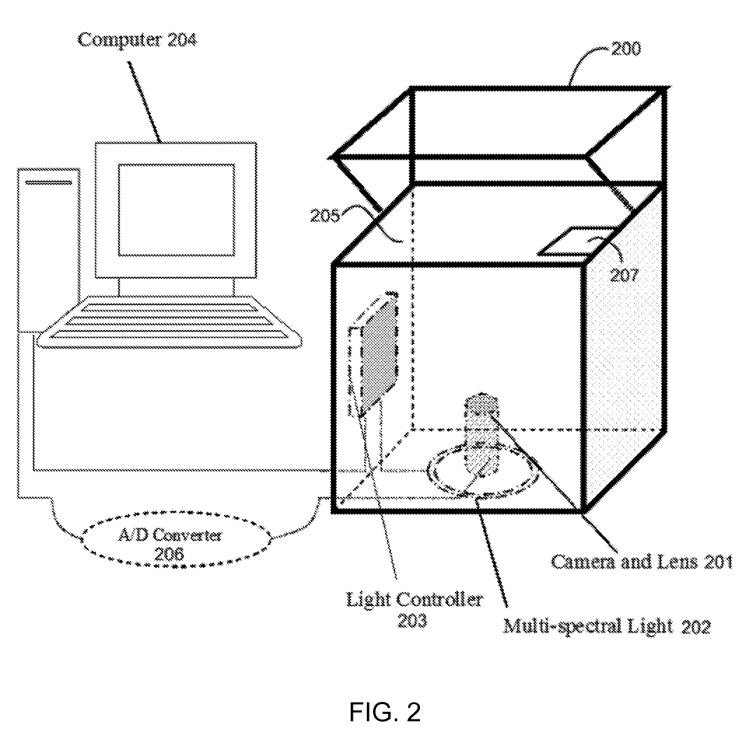

FIG. 2 illustrates the structure of a multispectral palmprint image acquisition device 200. It includes a digital camera (e.g., charge-coupled device (CCD) or CMOS imaging device) and lens 201, an A/D converter 206, a multispectral light source 202, and a light controller 203. A monochromatic CCD 201 is placed at the bottom of the device. The Analog/Digital converter 206, which connects to the CCD camera 201 and the computer 204 via a cable, is capable of converting analog images into digital images. The light controller 203 is configured to control the multispectral light 202. It is capable of communicating with computer 204 and receiving instructions from computer 204 to control the multispectral light 202. In another embodiment, the computer is integrated with the multispectral palmprint image acquisition device 200 as a standalone unit. An infrared sensor 207 is configured to detect the presence of a hand. Thus, upon detecting the presence of a hand from the infrared sensor 207, the multispectral light 202 activates its light array in sequence and the CCD camera captures the palmprint images in the various spectral bands.

Computer 204 includes a central processing unit (CPU), data storage, input/output interface, graphic card, and display. The data storage unit is capable of storing computer-executable program codes for palmprint verification. The CPU is capable of executing program codes stored in the data storage unit. Input/output interface enables data to input and output from multispectral palmprint image acquisition device 200. Graphic card is capable of outputting images such as palmprint images on the display.

The CCD camera is capable of capturing palmprint images in various resolutions such as 352×288 or 704×576. A user is asked to place his or her palm on the platform 205. Several pegs serve as control points for the placement of the user's hands. Thus, pegs can be used to position a user's hand at a specific location. Then, four palmprint images of the palm are sequentially collected under different spectral lights, namely red light, blue light, green light and NIR light. The switching time between the two consecutive lights is very short, and the four images can be captured in a relatively short time (<1 s).

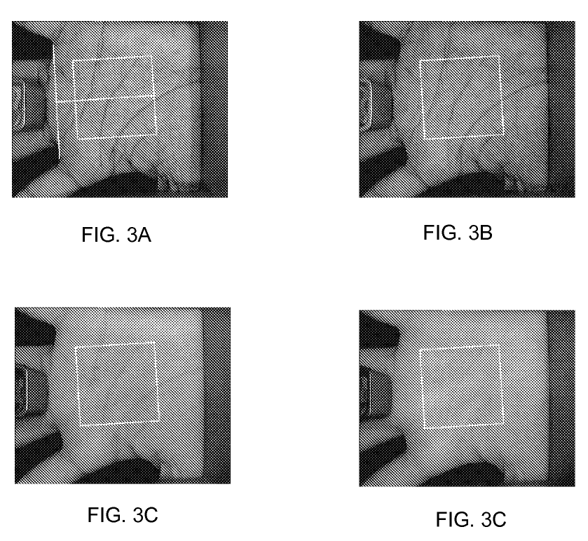

FIGS. 3A to 3D show a typical multispectral palmprint sample in the Blue (FIG. 3A), Green (FIG. 3B), Red (FIG. 3C), and NIR (FIG. 3D) bands. It can be observed that the line features are clearer in the Blue and Green bands than in the Red and NIR bands. While the Red band reveals some vein structure, the NIR band can show the palm vein structures as well as partial line information.

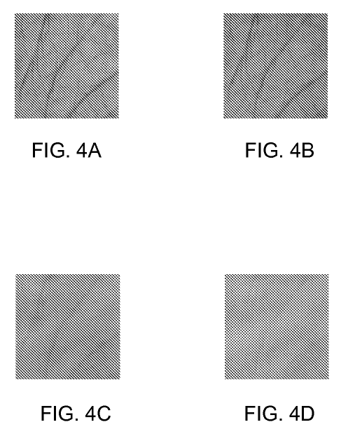

Next, a sub-image is extracted from the palmprint image for further feature extraction and matching. This can reduce the data amount in feature extraction and matching and reduce the influence of rotation and translation of the palm. The sub-image extraction algorithm described in U.S. Pat. No. 7,466,846 can be used, the entire disclosure of U.S. Pat. No. 7,466,846 is incorporated by reference herein. It can be applied to a palmprint image captured at one of the multispectral band to find the sub-image coordinate system. FIGS. 3A to 3D show the sub-image of the palmprint image where FIG. 3A is captured under blue band, FIG. 3B is captured under green band; FIG. 3C is captured under red band, FIG. 3D is captured under NIR band. The square regions in FIGS. 3A to 3D indicate the sub-image and FIGS. 4A to 4D illustrates the cropped sub-image images of FIGS. 3A to 3D, respectively.

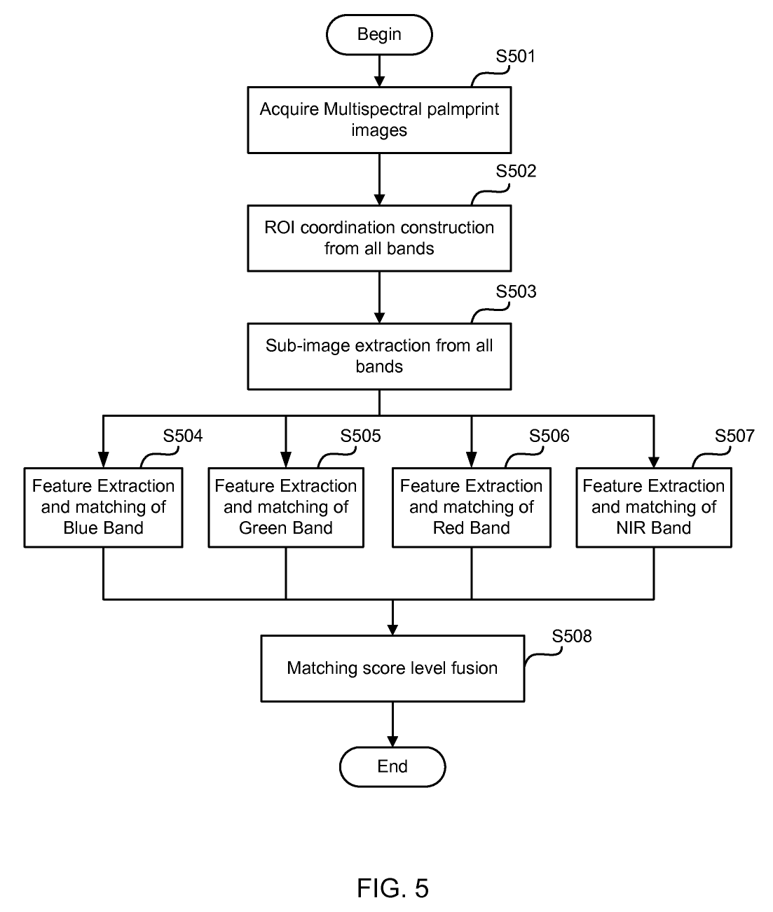

After obtaining the sub-image for each band, feature extraction and matching will be applied to these sub-image images. The final verification decision will be made by score-level fusion of all bands. FIG. 5 shows an exemplary process flow of the present multispectral palmprint verification.

In step S501, four palmprint images under four different spectral bands are acquired at the multispectral palmprint device. While palmprint images are captured under different multispectral bands, the images can be monochromatic images. The palmprint images are converted into digital formats by A/D converter 206, and transferred to computer 204. Next, in step S502, sub-images of the palmprint images are constructed and extracted in step S503. Then, features extraction and matching scores are calculated at each band in steps S504 to S507. Next, score-level fusion is performed based on the extracted palmprint features. In step S508. Further information to each of the steps is explained in more details below.

Feature Extraction and Matching for Each Band

The present system employs orientation-based coding, as described in “Competitive Coding Scheme for Palmprint Verification” by Kong and Zhang, for feature extraction. Using the sub-images from different bands, orientation information is extracted. To capture orientation information from palm lines, tunable filters such as Gabor filter may be utilized. For example, by viewing the line features in palmprint images as negative lines, six Gabor filters are applied along different directions (θⱼ=jπ/6, where j={0,1,2,3,4,5}) to the palmprint images for orientation feature extraction. For each pixel, the orientation corresponding to the minimal response is taken as the feature at this pixel. The Gabor filter can be expressed as:

$$ψ ( x , y , ω , θ ) = \frac{ω}{\sqrt{2 πκ}} {e}^{- \frac{{ω}^{2}}{8 {κ}^{2}} ( 4 {x}^{′2} + {y}^{′2} )} ( {e}^{iω {x}^{′}} - {e}^{- \frac{{κ}^{2}}{2}} ) \qquad ( 1 )$$

where

x′=(x−x₀)cos θ+(y−y₀)sin θ, y′=−(x−x₀)sin θ+(y−y₀)cos θ is the center of the function, ω is the radial frequency in radians per unit length, θ is the orientation of the Gabor functions in radians,

$$κ = \sqrt{2 ln 2} ( \frac{{2}^{φ} + 1}{{2}^{φ} - 1} )$$

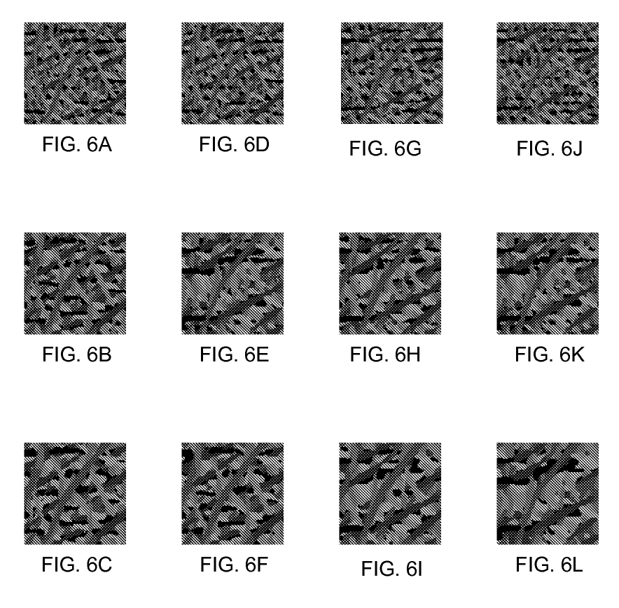

and φ is the half-amplitude bandwidth of the frequency response. To reduce the influence of illumination, the DC (direct current) is removed from the filter. FIGS. 6A to 6L illustrate some feature maps extracted from FIG. 4 using a variety of parameters in which different gray values represent different orientation features. The three maps in each column from left to right are all extracted from the same sub-image but using three different parameters. Thus, FIGS. 6A to 6C are extracted from blue; FIGS. 6D to 6F are extracted from green; FIGS. 6G to 6I are extracted from red; FIGS. 6J to 6L are extracted from NIR, where the same setting is used for each row.

Since there are total of 6 different orientations, it can be coded by using 3 bits as listed in Table I. This coding scheme is to make the bitwise difference proportional to the angular difference. The difference between two orientation maps (the matching score of the two orientation maps) can be measured by using Hamming distance:

$$D ( P , Q ) = \frac{{\sum }_{y = 0}^{M} {\sum }_{x = 0}^{N} {\sum }_{i = 1}^{3} ( {P}_{i}^{b} ( x , y ) ⊗ {Q}_{i}^{b} ( x , y ) )}{3 M * N} \qquad ( 2 )$$

where P and Q represent two palmprint orientation feature maps, Pᵢ^{b} and Qᵢ^{b} are the i^{th} bit plane of P and Q in one band, respectively. M and N indicate the size of feature maps. Symbol “\textcircled{X}” represents bitwise exclusive OR. Obviously, D is between 0 and 1, and for a perfect matching the distance will be 0. Table I below illustrates the bitwise representation of the orientation coding.

TABLE I

| Orientation | | | |
|---|---|---|---|
| Value | Bit 0 | Bit 1 | Bit 2 |
| 0 | 0 | 0 | 0 |
| π/6 | 0 | 0 | 1 |
| π/3 | 0 | 1 | 1 |
| π/2 | 1 | 1 | 1 |
| 2π/3 | 1 | 1 | 0 |
| 5π/6 | 1 | 0 | 0 |

To further reduce the influence of imperfect sub-image extraction, in matching we translate one of the two feature maps vertically and horizontally from −3 to 3. The minimal distance obtained by translated matching is treated as the final distance or the final matching score.

Inter-Spectral Correlation Analysis

To remove the redundant information of multispectral images, the correlation between different bands is evaluated quantitatively. By using the Gabor filter in Eq. (1), palmprint features are extracted for each spectral band individually, and then the inter-spectral distance is computed by Eq. (2) for the same palm. Table II shows the statistics of inter-spectral distance and Table III shows that of intra-spectral distance. Table II illustrates that as the difference between spectrum increases, the feature difference increases. For example, the average difference between Blue and Green is 0.1571, while that of Blue and NIR is 0.3910. This indicates that different spectra can be used to highlight different textural components of the palm. Meanwhile, compared with the impostor distance, which can be assumed to be independent and close to 0.5 as discussed in “The importance of being random: statistical principles of iris recognition” by Daugman, Pattern Recognition, the inter-spectral distance is much smaller, which shows that different spectral bands are correlated rather than independent.

TABLE II
Statistic of inter-spectral distance

Mean/Minimal/Maximal of Distance

| | Blue | Green | Red | NIR |
|---|---|---|---|---|
| Blue | 0 | 0.1571/ | 0.3110/ | 0.3910/ |
| | | 0.0915/ | 0.2083/ | 0.2884/ |
| | | 0.3441 | 0.4420 | 0.4801 |
| Green | | 0 | 0.3030/ | 0.3840/ |
| | | | 0.2002/ | 0.2920/ |
| | | | 0.4486 | 0.4650 |
| Red | | | 0 | 0.2566/ |
| | | | | 0.1523/ |
| | | | | 0.3828 |
| NIR | | | | 0 |

TABLE III
Statistic of intra-spectral distance.

| | Mean of | Mean of |
|---|---|---|
| Spectrum | Genuine | Impostor |
| Blue | 0.2600 | 0.4621 |
| Green | 0.2686 | 0.4643 |
| Red | 0.2143 | 0.4561 |
| NIR | 0.2511 | 0.4627 |

Score Level Fusion Scheme

Generally, more information is used, better performance could be achieved. However, since there is some overlapping of the discriminating information between different bands, simple sum of the matching scores of all bands may not improve much the final accuracy. Suppose there are k kinds of features (Fᵢ^{X}, i={1, 2, . . . , k}). For two samples X and Y, the distance using simple sum rule is defined as:

$${d}_{Sum} ( X , Y ) = {\sum }_{i = 1}^{k} d ( {F}_{i}^{X} , {F}_{i}^{Y} ) \qquad ( 3 )$$

where d(Fᵢ^{X},Fᵢ^{Y}) is the distance for the i^{th} feature.

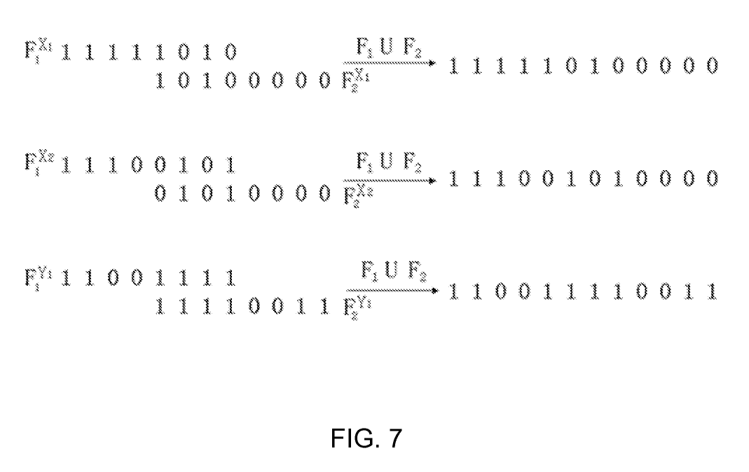

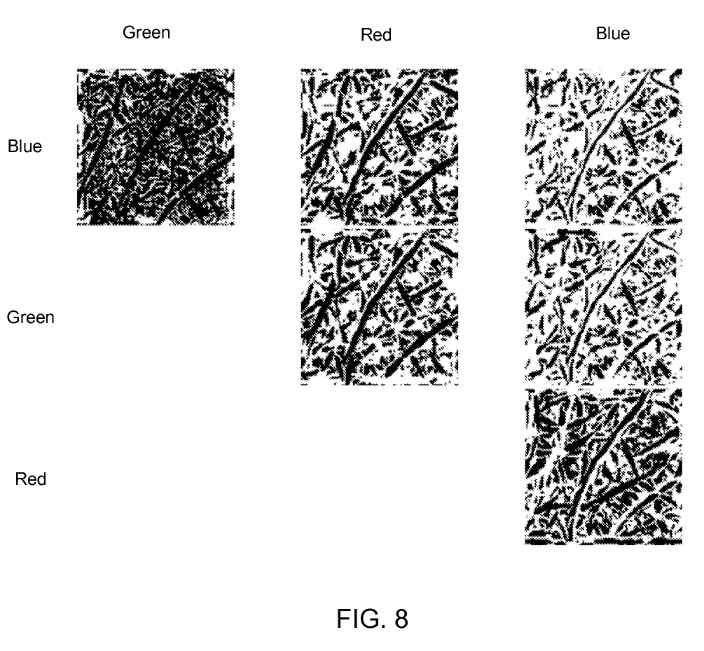

FIG. 7 illustrates an example of score level fusion by summation. There are two kinds of features (Fᵢ^{X},i={1,2}) for three samples {X₁,X₂,Y}, where X₁ and X₂ belong to the same type of object and Y₁ belongs to another object. By Eq. (3), the score level fusion by summation is determined as d_{Sum}(X₁,X₂)=9 and d_{Sum}(X₁,Y₁)=8. However, the true distances between X₁ and X₂, and X₁ and Y₁ without information overlapping should be 5 and 6, respectively. Because there is an overlapping part between the two features, it will be counted twice by using the sum rule (3). Sometime, such kind of over-computing may make the simple score level fusion fail as illustrated in the above example. For multispectral palmprint images, most of the overlapping features between two spectral bands locate on the principal lines. FIG. 8 illustrates the overlapping features between different spectra where black pixels represent overlapping features, whereas white pixels represent non-overlapping features. By using the sum rule of Eq. (3), those line features will be double-counted so that it may fail to classify two palms with similar principal lines.

According to one embodiment, the present invention provides a score-level fusion method to reduce the overlapping effect, and hence, improves verification result. The union (U) operator in set theory, which is defined as follows:

X∪Y=X+Y−X∩Y (4)

Based on Eq. (4), the present invention defines a score-level fusion rule which minimizes the overlapping effect of the fused score:

$$\begin{matrix}{d}_{{F}_{1} ⋃ {F}_{2}} ( X , Y ) = d ( {F}_{1} ) + d ( {F}_{2} ) - d ( {F}_{1} ⋂ {F}_{2} ) \\ = d ( {F}_{1}^{X} , {F}_{1}^{Y} ) + d ( {F}_{2}^{X} , {F}_{2}^{Y} ) - \\ \frac{( d ( {F}_{1}^{X} , {F}_{1}^{Y} ) + d ( {F}_{2}^{X} , {F}_{2}^{Y} ) )}{2} {P}_{OP} ( {F}_{1} , {F}_{2} )\end{matrix} \qquad ( 5 )$$

where P_{OP}(F₁,F₂) is the overlapping percentage between two feature maps. Here two assumptions are made. First it is assumed that the overlapping percentage of two feature maps is nearly the same for different palms. There are two reasons for making this assumption. One is that the difference of overlapping percentage between different palms is relatively small, as can be seen in Table IV. The other one is that although P_{OP}(F₁,F₂) can be computed for any given two feature maps, it will spend a large computational cost and hence may be a burden in time demanding applications. Thus, to improve the processing speed, P_{OP}(F₁,F₂) can be fixed as the average value computed from a training set. The second assumption is that the overlapping is uniformly distributed across the feature map. Thus, is

$$\frac{( d ( {F}_{1}^{X} , {F}_{1}^{Y} ) + d ( {F}_{2}^{X} , {F}_{2}^{Y} ) )}{2} {P}_{OP} ( {F}_{1} , {F}_{2} )$$

used as an approximation distance in the overlapping region.

By using (5), the distances between X₁ and X₂, and X₁ and Y become 6.75 and 6, respectively. It is much closer to the real distance than using Eq. (3). Similarly, the fusion scheme can be utilized to fuse more bands, e.g. 3 spectral bands as in equation (6):

$${d}_{{F}_{1} ⋃ {F}_{2} ⋃ {F}_{3}} ( X , Y ) = d ( {F}_{1}^{X} , {F}_{1}^{Y} ) + d ( {F}_{2}^{X} , {F}_{2}^{Y} ) + d ( {F}_{3}^{X} , {F}_{3}^{Y} ) - \frac{( d ( {F}_{1}^{X} , {F}_{1}^{Y} ) + d ( {F}_{2}^{X} , {F}_{2}^{Y} ) )}{2} * {P}_{OP} ( {F}_{1} , {F}_{2} ) - \frac{( d ( {F}_{1}^{X} , {F}_{1}^{Y} ) + d ( {F}_{3}^{X} , {F}_{3}^{Y} ) )}{2} * {P}_{OP} ( {F}_{1} , {F}_{3} ) - \frac{( d ( {F}_{2}^{X} , {F}_{2}^{Y} ) + d ( {F}_{3}^{X} , {F}_{3}^{Y} ) )}{2} * {P}_{OP} ( {F}_{2} , {F}_{3} ) + \frac{( d ( {F}_{1}^{X} , {F}_{1}^{Y} ) + d ( {F}_{2}^{X} , {F}_{2}^{Y} ) + d ( {F}_{3}^{X} , {F}_{3}^{Y} ) )}{3} * {P}_{OP} ( {F}_{1} , {F}_{2} , {F}_{3} ) \qquad ( 6 )$$

Next, the fused score is compared with a threshold score of a palmprint image in the database to determine whether the palmprint is genuine. The threshold score is determined by a system administrator. For example, if the system is used for low level security applications, the score is set to high value. On the other hand, if the system is used for high level security applications, the score is set to a low value.

Table IV below illustrates the statistical percentage (%) of overlapping features among different spectral bands on a training set.

TABLE IV

| Spectra | Mean Percentage | Standard Percentage |
|---|---|---|
| Blue and Green | 72.6535 | 3.9052 |
| Blue and Red | 47.0632 | 4.9618 |
| Blue and NIR | 33.6842 | 5.0552 |
| Green and Red | 47.3961 | 4.3286 |
| Green and NIR | 34.3067 | 4.6105 |
| Red and NIR | 55.2617 | 5.5367 |
| Blue, Green and Red | 38.8421 | 4.6939 |
| Blue, Green and NIR | 26.9385 | 4.3295 |
| Blue, Red and NIR | 26.3367 | 4.3802 |
| Green, Red and NIR | 26.8390 | 4.2041 |
| Blue, Green, Red and NIR | 21.9879 | 3.9503 |

Because different bands highlight different features of the palm, these features may provide different discriminate capabilities. It is intuitive to use weighted sum:

$${d}_{WeightSum} = {\sum }_{i = 1}^{n} {w}_{i} {d}_{i} \qquad ( 7 )$$

where wᵢ is the weight on dᵢ, the distance in the i^{th} band, and n is the number of total bands. Eq. (3) can be regarded as a special case of Eq. (7) when the weight is 1 for each spectrum.

The method described above may be implemented in a computer-executable program code that is stored in a computer-readable storage medium of a computer. And thus, by executing the program code can be executed by the computer to perform the process flow described in FIG. 3.

Using the reciprocal of EER (Equal Error Rate, a point when False Accept Rate (FAR) is equal to False Reject Rate (FRR)) as weight is widely used in Biometric System, as discussed in “Large-Scale Evaluation of Multimodal Biometric Authentication Using State-of-the-Art Systems” by Snelick et al. Taking dᵢ′=wᵢdᵢ as the normalized distance for band i, the score level fusion scheme can be extended to a weighted sum: multiply original distance with the weight for normalization, and then substitute the new distance into Eq. (5) or (6).

To test the present multispectral palmprint verification system, multispectral palmprint images are collected from 250 individuals. For each individual, 4 images from the four bands (Red, Green, Blue and NIR) are acquired in less than one second. The resolution of the images is 352 by 288 (<100 dpi).

As shown in FIGS. 4A-4D, different bands can have different features of palm, providing different discriminate information for personal authentication. For different bands, different parameters should be used for better recognition results.

In the experiment, a subset of 3000 images for each band is used. The subset is used for parameter selection in feature extraction. To obtain the verification accuracy, each palmprint image is matched with all the other palmprint images of the same band in the database. A match is counted as a genuine matching if the two palmprint images are from the same palm; otherwise, the match is counted as impostor matching. The total number of matches is 3000×2999/2=4,498,500, and among them there are 7,500 (6×500×5/2) genuine matching, others are impostor matching. The EER is used to evaluate the performance.

As stated above, there are two variables for the Gabor filter: κ and ω. It is impossible to search exhaustively in the parameter space to find the optimal parameters for each band. Thus, 20 different values for κ and 15 different values for ω are evaluated in this experiment. Here, the Gabor filter size is fixed as 35×35.

A sample of statistics of the EER is listed in Table V. Because of the different spectral characteristics of different bands, the optimal (corresponding to minimal EER) parameters for different bands are different. Some findings could be found from Table V. Firstly, Red and NIR bands have better EER than Blue and Green bands. This is mainly because Red and NIR not only capture most of palm line information, but also capture some palm vein structures. This additional palm vein information helps classify those palms with similar palm lines.

TABLE V

| EER (%) | Blue | Green | Red | NIR |
|---|---|---|---|---|
| Mean | 0.0712 | 0.0641 | 0.0257 | 0.0430 |
| Std | 0.0142 | 0.0170 | 0.0217 | 0.0340 |
| Median | 0.0669 | 0.0666 | 0.0153 | 0.0378 |
| Minimal | 0.0400 | 0.0293 | 0.0015 | 0.0114 |
| Maximal | 0.1332 | 0.1607 | 0.1601 | 0.2665 |

Secondly, the EER of NIR is higher than that of Red. There are mainly two reasons. First, the palm lines in NIR band is not as strong as those in the Red band because NIR light can penetrate deeper the palm skin than Red light, which attenuates the reflectance. Second, some people, especially females, have very weak vein structures under NIR light because their skin is a little thicker.

Palmprint Verification by Fusion

The four bands can be fused to further improve the palmprint verification accuracy. Table VI lists the accuracy results by four different fusion schemes, original weighted sum (w=1), proposed weighted sum (w=1), original weighted sum (w=1/EER) and proposed weighted sum (w=1/EER). Some findings could be obtained. Firstly, all fusion schemes can result in smaller EER than a single band except the fusion of Blue and Green (this is because the feature overlapping between them is very high), which validate the effectiveness of multispectral palmprint authentication. Secondly, using the reciprocal of EER as weight usually leads to better results than the equal weight scheme. Thirdly, the proposed fusion scheme, which could reduce the feature overlapping effect, achieves better results than the original weighted sum method. It can be verified that Eq. (5) can be rewritten as Eq. (7) and it is actually a weighted ((1−P_{OP}(F₁,F₂))) distance of Eq. (3). The best result is obtained by fusing Red and Blue bands, which leads an EER as low as 0.0121%, which demonstrated a higher accuracy over prior systems.

TABLE VI

| | EER (%) | | | |
|---|---|---|---|---|
| | Original | Proposed | Original | Proposed |
| | Weighted | Weighted | Weighted | Weighted |
| | Sum | Sum | Sum | Sum |
| | (w = 1) | (w = 1) | (w = 1/EER) | (w = 1/EER) |
| Blue, Green | 0.0425 | 0.0425 | 0.0397 | 0.0397 |
| Blue, Red | 0.0154 | 0.0154 | 0.0121 | 0.0121 |
| Blue, NIR | 0.0212 | 0.0212 | 0.0212 | 0.0212 |
| Green, Red | 0.0212 | 0.0212 | 0.0182 | 0.0182 |
| Green, NIR | 0.0242 | 0.0242 | 0.0181 | 0.0181 |
| Red, NIR | 0.0152 | 0.0152 | 0.0152 | 0.0152 |
| Blue, Green, | 0.0243 | 0.0212 | 0.0152 | 0.0151 |
| Red | | | | |
| Blue, Green, | 0.0212 | 0.0214 | 0.0212 | 0.0212 |
| NIR | | | | |
| Blue, Red, | 0.0121 | 0.0121 | 0.0121 | 0.0121 |
| NIR | | | | |
| Green, Red, | 0.0153 | 0.0156 | 0.0152 | 0.0150 |
| NIR | | | | |
| Blue, Green, | 0.0152 | 0.0151 | 0.0121 | 0.0121 |
| Red, NIR | | | | |

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

What is claimed is:

1. A method for palmprint verification of an individual, the method comprising:
illuminating a palm of an individual with a plurality of spectral bands;
collecting a plurality of palmprint images that are illuminated under the different spectral bands;
locating a sub-image from each of the plurality of palmprint images;
extracting palmprint feature maps from the sub-images;
determining a palmprint matching score for each of the spectral bands based on the palmprint feature maps;
computing a fused score by combining at least two of the palmprint matching scores under different spectral bands, without double-counting overlapping regions; and
comparing the fused score with a threshold score from a database.

2. The method of claim 1, wherein the different spectral bands include red, green, blue and near-infrared.

3. The method of claim 1, wherein the fused score is determined from a weighted sum.

4. The method of claim 1, wherein the palmprint matching score is based on distances among palmprint feature maps.

5. The method of claim 1, further comprises capturing orientation information from palm lines using tunable filters.

6. The method of claim 1, wherein the plurality of palmprint images are monochromatic images.

7. The method of claim 1, wherein the fused score is determined by
$$\begin{matrix}{d}_{{F}_{1} ⋃ {F}_{2}} ( X , Y ) = d ( {F}_{1} ) + d ( {F}_{2} ) - d ( {F}_{1} ⋂ {F}_{2} ) \\ = d ( {F}_{1}^{X} , {F}_{1}^{Y} ) + d ( {F}_{2}^{X} , {F}_{2}^{Y} ) - \\ \frac{( d ( {F}_{1}^{X} , {F}_{1}^{Y} ) + d ( {F}_{2}^{X} , {F}_{2}^{Y} ) )}{2} * {P}_{OP} ( {F}_{1} , {F}_{2} ) ,\end{matrix}$$
where F₁ and F₂ are two palmprint feature maps, F₁^{X},F₁^{Y} are feature maps from palmprint image X and palmprint image Y, and F₂^{X}, F₂^{Y} are different feature maps from palmprint X and palmprint Y, P_{OP}(F₁,F₂) is an average value computed from the database.

8. A system for palmprint verification of an individual, comprising:
an illuminating unit configured to illuminate a palm of an individual with a plurality of spectral bands;
an image acquisition unit configured to collect a plurality of palmprint images that are illuminated under the different spectral bands; and
a computer configured to:
locate a sub-image from each of the plurality of palmprint images;
extract palmprint feature maps from the sub-images;
determine a palmprint matching score for each of the spectral bands based on the palmprint feature maps;
compute a fused score by combining at least two of the palmprint matching scores under different spectral bands, without double-counting overlapping regions; and
compare the fused score with a threshold score from a database.

9. The system of claim 8, wherein the illuminating unit comprises a plurality of LED arrays configured to illuminate at different spectral bands.

10. The system of claim 8, wherein the illuminating unit comprises a monochromic camera.

11. The system of claim 8, wherein the image acquisition unit includes pegs that allow a user to position his/her palm at a specific location.
